(19) United States
(12) Patent Application Publication
(10) Pub. No.: US 2023/0236820 A1
(43) Pub. Date: Jul. 27, 2023

(54) METHOD FOR RECEIVING FIRMWARE AND METHOD FOR TRANSMITTING FIRMWARE

(71) Applicant: UNIONPLACE CO., LTD., Seoul (KR)

(72) Inventors: Seongcheol BANG, Seoul (KR); Youngkyu SHIN, Seoul (KR); Seunggyeom KIM, Seoul (KR); Yoongoo KIM, Seoul (KR)

(73) Assignee: UNIONPLACE CO., LTD., Seoul (KR)

(21) Appl. No.: 18/127,340

(22) Filed: Mar. 28, 2023

Related U.S. Application Data
(63) Continuation of application No. PCT/KR2022/015323, filed on Oct. 12, 2022.

(30) Foreign Application Priority Data
Dec. 24, 2021 (KR) 10-2021-0186743

(51) Int. Cl. G06F 8/65; H04L 9/32; G06F 21/57

(52) U.S. Cl. CPC G06F 8/65; H04L 9/3242; G06F 21/572; G06F 2221/033

(57) ABSTRACT

A method for receiving firmware including pieces of firmware data is provided. The method is performed by a first apparatus in a multicast group including at least the first apparatus and a second apparatus. The method includes (a) receiving first meta-information for the firmware data from the second apparatus, (b) generating, based on the first meta-information, second meta-information for at least one piece of firmware data to be used to apply the firmware to the first apparatus, among the firmware data, and (c) receiving, based on the second meta-information, the at least one piece of firmware data from a firmware providing apparatus or the second apparatus. The first meta-information includes at least history information including version and partitioning information for each of the pieces of firmware data, and the second meta-information includes at least the history information for each of the at least one piece of firmware data.

### CROSS-REFERENCE TO RELATED PATENT APPLICATION

This non-provisional U.S. patent application is a bypass continuation application of PCT International Application No. PCT/KR2022/015323, filed on Oct. 12, 2022, in the WIPO, the international application being based upon and claiming the benefit of priority from Korean Patent Application No. 10-2021-0186743, filed on Dec. 24, 2021, in the Korean Intellectual Property Office, the entire contents of which are hereby incorporated by reference.

### BACKGROUND

### 1. Field

The present disclosure relates to a method for an apparatus in a multicast group to receive firmware and a method for an apparatus providing firmware to transmit the firmware to a plurality of apparatuses in the multicast group.

The technique disclosed herein was supported by Korea Evaluation Institute of Industrial Technology (KEIT) grant funded by the Korea government (the Ministry of Trade, Industry and Energy (MOTIE)) (Project name: “Development Intelligent Object on AI Applet MCU for High Speed Secure Network,” Project No.: 20017978).

### 2. Related Art

A variety of apparatuses may be connected to a network. In the present specification, apparatuses having communication and computing capabilities are simply referred to as “computing apparatuses” or “apparatuses.”

In order to update firmware of an apparatus, for example, a technology of firmware over-the-air (FOTA) may be used. With FOTA, the apparatus can download and update the firmware thereof over a wireless network.

Meanwhile, a plurality of apparatuses may be grouped as a multicast group. An apparatus that transmits data (hereinafter, also referred to as a “transmitter”) may transmit data to the plurality of apparatuses within the multicast group by using a multicast method. In the multicast method, a multicast address that is set for the multicast group is used.

The plurality of apparatuses in the multicast group sequentially communicate with an apparatus providing firmware by using a unicast method in order to update the firmware. For example, when there are a first apparatus to an n-th apparatus (“n” is a natural number of 2 or greater) in the multicast group, the apparatus providing firmware sequentially provides the firmware to the first apparatus to the n-th apparatus by using the unicast method in such a manner that the apparatus providing firmware provides the firmware to the first apparatus and then provides the firmware to the subsequent apparatus. Even when the plurality of apparatuses in the multicast group have substantially the same configuration (that is, even when the firmware is the same), the plurality of apparatuses sequentially communicate with the apparatus providing the firmware by using the unicast method in order to update the firmware. Therefore, it takes a lot of time for each of the plurality of apparatuses in the multicast group to update its firmware. In addition, a communication load in the multicast network also increases.

In order to make up for the above shortcoming, Korean Patent registration No. 10-1757417 (Patent Document 1), which is filed by JUBIX Co., Ltd., discloses a firmware update method using both a broadcast method and a unicast method.

According to Korean Patent Registration No. 10-1757417, a gateway receives firmware from a parent apparatus (which corresponds to an apparatus providing the firmware in the present specification), divides the firmware into a plurality of images, assigns a sequence number to each of the plurality of images, and transmits the plurality of images to a plurality of apparatuses by using the broadcast method. Further, when one or more apparatuses among the plurality of apparatuses fail to receive one or more images among the plurality of images, the gateway uses a unicast method to transmit the one or more images that have not been received by the one or more apparatuses to the one or more apparatuses based on the sequence number.

However, according to Korean Patent Registration No. 10-1757417, the gateway is used in addition to the apparatus providing firmware, and the gateway can provide firmware only to a plurality of apparatuses within a limited area directly connected to the gateway. Therefore, the application target is limited.

Further, according to Korean Patent Registration No. 10-1757417, the firmware is transmitted to the plurality of apparatuses by using the broadcast method, which leads to a vulnerability in security. More specifically, according to Korean Patent Registration No. 10-1757417, a checksum of the firmware is used to verify that the firmware is normally transmitted. However, even in the case when any one of the plurality of apparatuses operates abnormally due to an attack such as hacking and the abnormally operating apparatus broadcasts tampered firmware, instead of normal firmware, to other apparatuses among the plurality of apparatuses, it is difficult for each of the plurality of apparatuses to determine whether the firmware has been forged or tampered with.

In addition, according to Korean Registered Patent No. 10-1757417, if any one of the plurality of apparatuses fails to receive the firmware, the corresponding apparatus needs to receive the firmware again from the gateway by using the unicast method. Accordingly, the communication load within the multicast network also increases.

For example, if any one of the plurality of apparatuses is powered off or in a standby state, or if a new apparatus joins the multicast group, the corresponding apparatus does not receive firmware transmitted from the gateway.

Accordingly, the corresponding apparatus is required to receive the firmware as a whole again from the gateway by using the unicast method.

### RELATED ART

### Patent document

Patent Document 1: Korean Registered Patent No. 10-1757417

### SUMMARY

It is an object of the technique of the present disclosure to provide a method for receiving firmware, the method being capable of obtaining at least a part of the firmware from a firmware providing apparatus or a neighboring apparatus based on history information of the firmware; easily determining whether firmware data has been forged and further determining the sequential order of the firmware data by using MAC and MAC chaining value; and receiving firmware data that has not been received again in a unicast manner or a multicast manner.

It is another object of the technique of the present disclosure to provide a method for transmitting firmware, the method being capable of transmitting the firmware while MAC and MAC chaining values are used to prevent a firmware tampering even when the firmware is transmitted in a multicast manner, and allowing an apparatus that receives the firmware to transmit only data necessary to apply the firmware based on history information of the firmware to thereby minimize a communication load.

In view of the above, according to one aspect of the technique of the present disclosure, there is provided a method for receiving firmware including multiple pieces of firmware data, which is performed by a first apparatus in a multicast group including at least the first apparatus and a second apparatus, the method including: (a) receiving first meta-information for the multiple pieces of firmware data from the second apparatus; (b) generating, based on the first meta-information, second meta-information for one or more pieces of firmware data to be used to apply the firmware to the first apparatus, among the multiple pieces of firmware data; and (c) receiving, based on the second meta-information, the one or more pieces of firmware data from an apparatus providing the firmware or the second apparatus. Further, the first meta-information includes at least history information including version information and partitioning information for each of the multiple pieces of firmware data, and the second meta-information includes at least the history information for each of the one or more pieces of firmware data.

According to another aspect of the technique of the present disclosure, there is provided a method for transmitting firmware to a plurality of apparatuses in a multicast group, which is performed by a firmware providing apparatus, the method including: (a) transmitting first data to n-th data respectively corresponding to first firmware data to n-th firmware data of the firmware to the plurality of apparatuses in the multicast group in a multicast manner, wherein “n” is a natural number of 2 or greater; (b) storing the first data to the n-th data; (c) receiving a request for transmission of i-th data among the first data to the n-th data from one or more apparatuses in the multicast group, wherein “i” is a natural number from 1 to n; and (d) transmitting the i-th data to the one or more apparatuses in a multicast manner or a unicast manner. Further, the i-th data includes history information including version information and partitioning information of i-th firmware data, a MAC chaining value, length information, the i-th firmware data, and the MAC. Further, the MAC of the i-th firmware data is generated and computed by using a first MAC generation algorithm that uses the MAC chaining value of the i-th firmware data, the length information, and the i-th firmware data as a relevant input. Further, the MAC chaining value of the i-th firmware data is generated and computed by using a second MAC generation algorithm that uses a MAC chaining value of (i-1)-th firmware data and the i-th firmware data as a relevant input, if “i” is not equal to 1.

According to the technique of the present disclosure, it is possible to obtain at least a part of firmware from an apparatus for providing firmware or a neighboring apparatus based on history information of the firmware. Further, by using MAC and MAC chaining values, it is possible to easily determine whether firmware data has been forged and further determine the sequential order of firmware data. Furthermore, for any missing firmware data that has not been received, the apparatus may receive the missing firmware data again in a unicast manner or a multicast manner.

Further, according to the technique of the present disclosure, even when the firmware is transmitted in a multicast manner, it is possible to transmit the firmware while the MAC and MAC chaining values are used to prevent the firmware tampering. In addition, by using the history information of the firmware, an apparatus that receives the firmware can transmit only the data necessary to apply the firmware based on the history information, thereby minimizing the communication load.

### BRIEF DESCRIPTION OF THE DRAWINGS

FIG. 1 is an exemplary flowchart of a method for receiving firmware according to a first embodiment of the technique of the present disclosure.

FIG. 2 is a diagram illustrating an exemplary configuration of an apparatus performing the method for receiving firmware according to the first embodiment of the technique of the present disclosure.

FIG. 3 is a diagram illustrating an example of a system environment in which the method for receiving firmware according to the first embodiment of the technique of the present disclosure is employed.

FIG. 4 is a diagram illustrating an example of a structure of first meta-information in the method for receiving firmware according to the first embodiment of the technique of the present disclosure.

FIG. 5 is a diagram illustrating an example of a structure of second meta-information in the method for receiving firmware according to the first embodiment of the technique of the present disclosure.

FIG. 6 is an exemplary flowchart of a process of receiving firmware data in the method for receiving firmware according to the first embodiment of the technique of the present disclosure.

FIG. 7 is a diagram illustrating an example of a structure of i-th data in the method for receiving firmware according to the first embodiment of the technique of the present disclosure.

FIG. 8 is an exemplary flowchart of a method for transmitting firmware according to a second embodiment of the technique of the present disclosure.

### DETAILED DESCRIPTION

Hereinafter, one or more embodiments (also simply referred to as “embodiments”) of the method for receiving firmware and the method for transmitting firmware according to the technique of the present disclosure will be described mainly with reference to the drawings. Meanwhile, in the drawings for describing the embodiments of the technique of the present disclosure, for the sake of convenience of description, only a part of the practical configurations may be illustrated or the practical configurations may be illustrated while a part of the practical configurations is omitted or changed. Further, relative dimensions and proportions of parts therein may be exaggerated or reduced in size.

### First Embodiment

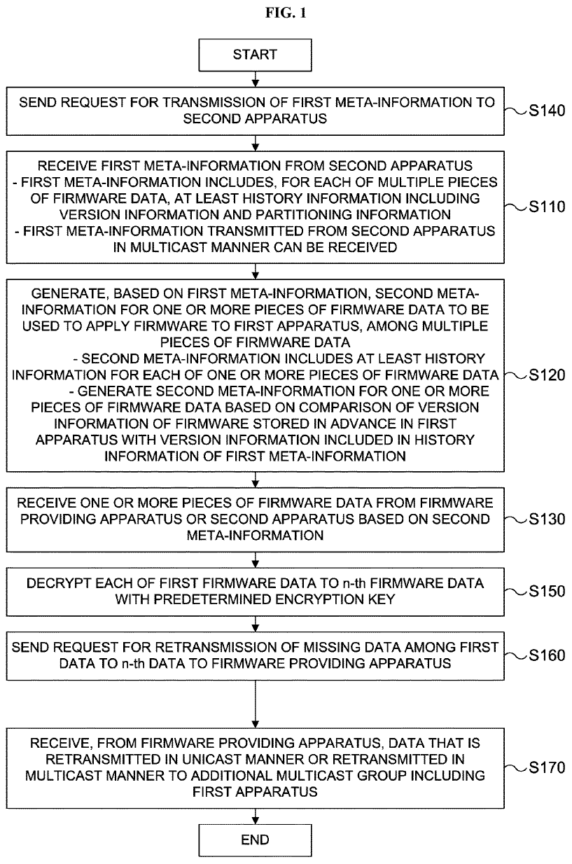

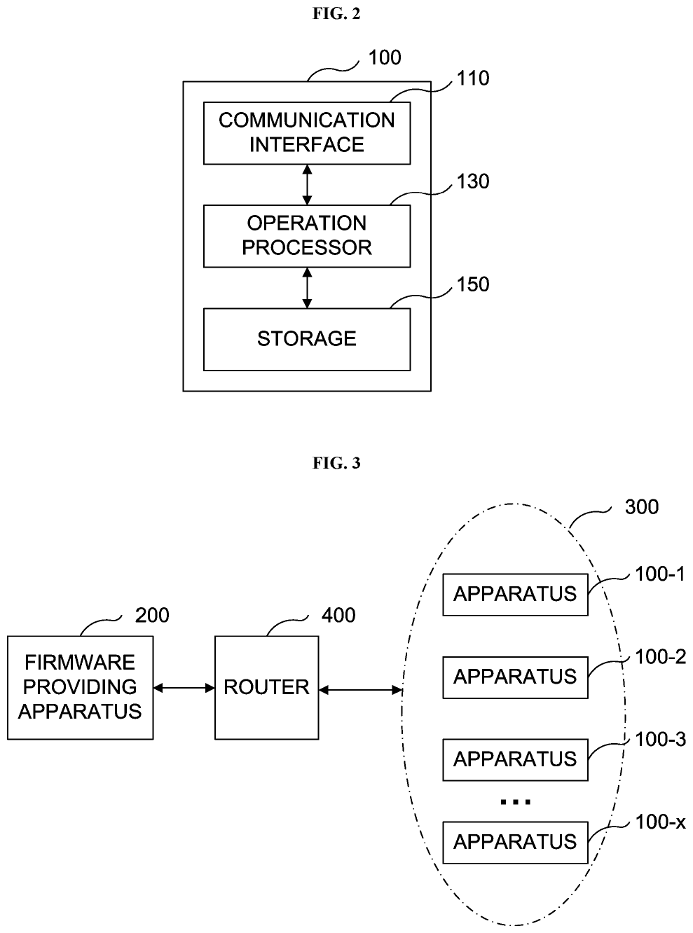

FIG. 1 is an exemplary flowchart of a method for receiving firmware according to a first embodiment of the technique of the present disclosure, and FIG. 2 is a diagram illustrating an exemplary configuration of an apparatus performing the method for receiving firmware according to the first embodiment of the technique of the present disclosure. FIG. 3 is a diagram illustrating an example of a system environment in which the method for receiving firmware according to the first embodiment of the technique of the present disclosure is employed.

Referring first to FIG. 2, there will be described an apparatus 100 performing the method for receiving firmware according to the first embodiment of the technique of the present disclosure.

Referring to FIG. 2, the apparatus 100 performing the method for receiving firmware may include a communication interface 110, an operation processor 130, and a storage 150.

The apparatus 100 may be implemented, for example, using a computing device having data acquisition capabilities, computing capabilities, and communication capabilities. For example, the apparatus 100 may include a computing device, such as a sensor, disposed within a multicast group.

The communication interface 110 is a communication interface that supports wired/wireless communications. The communication interface 110 may be implemented by a semiconductor device such as a communication chip. For example, the communication interface 110 may receive data in a unicast manner or a multicast manner.

The operation processor 130 may be implemented by a semiconductor device, such as a central processing unit (CPU), an application specific integrated circuit (ASIC), or the like.

The operation processor 130 may be implemented, for example, using a plurality of semiconductor devices.

For example, the operation processor 130 may be implemented using a first semiconductor device performing a control function, a second semiconductor device performing encoding/decoding of data, and a third semiconductor device performing encryption/decryption of data.

The operation processor 130 is configured to perform the method for receiving firmware according to the first embodiment, which will be described later, and may control the communication interface 110 and the storage 150 to execute the method for receiving firmware according to the first embodiment.

The storage 150 stores data. The storage 150 may be implemented by a semiconductor device, such as a semiconductor memory. The storage 150 may store information that is used or generated during the execution of the method for receiving firmware according to the first embodiment.

Next, referring to FIG. 3, there will be described an example of a system environment in which the method for receiving the firmware according to the first embodiment of the technique of the present disclosure is employed.

Referring to FIG. 3, a plurality of apparatuses, i.e., apparatuses 100-1 to 100-x, are located in a network. Here, x is an integer greater than or equal to 2.

Each of the apparatuses 100-1 to 100-x includes a communication interface, an operation processor, and a storage that respectively correspond to the communication interface 110, the operation processor 130, and the storage 150 of the apparatus 100.

At least one of the apparatuses 100-1 to 100-x may store first meta-information to be described later. At least one of the apparatuses 100-1 to 100-x may further store i-th data to be described later.

Hereinafter, an apparatus that stores the first meta-information among the apparatuses 100-1 to 100-x will be referred to as a “second apparatus,” when necessary.

Further, hereinafter, among the apparatuses 100-1 to 100-x, each of an apparatus that newly joins the multicast group, an apparatus that is powered on from the power-off state, and an apparatus that shifts to a normal state (e.g., an active mode) from a standby state (e.g., a sleep mode) is referred to as a “first apparatus” or simply referred to as the “apparatus 100.”

A firmware providing apparatus 200 is an apparatus that transmits firmware to the plurality of apparatuses, i.e., the apparatuses 100-1 to 100-x. The firmware providing apparatus 200 may be also referred to as the apparatus 200. The apparatus 200 may be implemented by a computing device including a communication interface (not shown), an operation processor (not shown), and a storage (not shown). Since a configuration of the apparatus 200 can be understand by referring to the configuration of the apparatus 100, a detailed description of the configuration of the apparatus 200 will be omitted.

A multicast group 300 includes the apparatuses 100-1 to 100-x.

For example, the apparatus 200 may transmit data to each of the apparatuses 100-1 to 100-x in a multicast manner by using a multicast address set for the multicast group 300. Alternatively, the apparatus 200 may transmit data to one of the plurality of apparatuses in a unicast manner by using an address set for the corresponding one of the plurality of apparatuses. For example, the apparatus 200 may transmit data to the apparatus 100-1 in a unicast manner by using an address set for the apparatus 100-1.

A router 400 is provided between the apparatus 200 and the multicast group 300 to transmit data to the apparatuses 100-1 to 100-x.

Hereinafter, the method of receiving the firmware according to the first embodiment of the technique of the present disclosure will be described in detail.

Referring to FIG. 1, in step S110, the apparatus 100 (i.e., the first apparatus) receives first meta-information for multiple pieces of firmware data from the second apparatus.

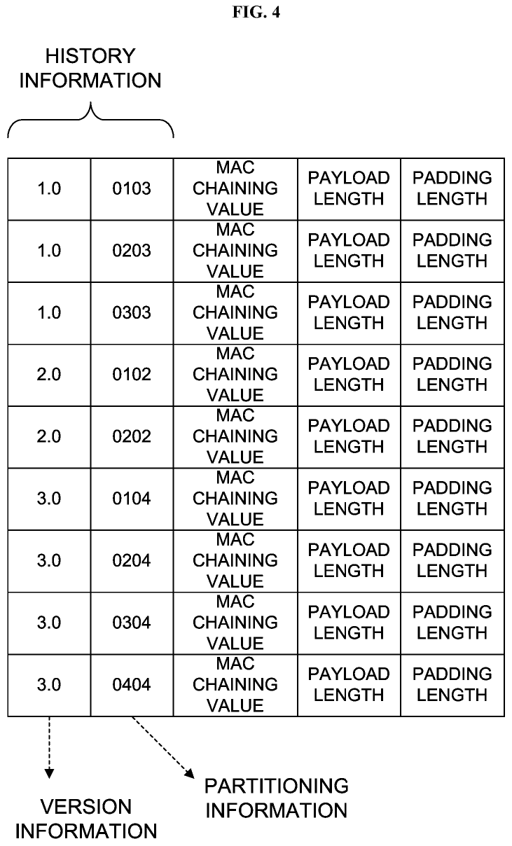

FIG. 4 is a diagram illustrating an example of a structure of the first meta-information in the method for receiving firmware according to the first embodiment of the technique of the present disclosure.

Referring to FIG. 4, the first meta-information includes, for each of the multiple pieces of firmware data, at least history information including version information and partitioning information.

The version information indicates each firmware version, for example.

For example, referring to FIG. 4, there are three pieces of firmware data for firmware of version 1.0, two pieces of firmware data for firmware of version 2.0, and four pieces of firmware data for firmware of version 3.0.

Preferably, the two pieces of firmware data for the firmware of version 2.0 may correspond to additional pieces of data required for upgrading the firmware to the firmware of version 2.0 based on the firmware of version 1.0 that has the three pieces of data, and the four pieces of firmware data for the firmware of version 3.0 may correspond to additional pieces of data required for upgrading the firmware to the firmware of version 3.0 based on the firmware of version 2.0 that has the two pieces of data. Thus, for example, if the apparatus 100 has the firmware of version 1.0 stored in advance and needs to update the firmware of version 1.0 to the firmware of version 3.0, the apparatus 100 may update the firmware of version 1.0 to the firmware of version 3.0 by receiving only the additional pieces of data required for upgrading the firmware to the firmware of version 2.0 from the firmware of version 1.0 and the additional pieces of data required for upgrading the firmware to the firmware of version 3.0 from the firmware of version 2.0.

Alternatively, the two pieces of firmware data for the firmware of version 2.0 may themselves constitute the firmware of version 2.0, and the four pieces of firmware data for the firmware of version 3.0 may themselves constitute the firmware of version 3.0.

The partitioning information may include the number of segments into which the firmware has been partitioned for each version. For example, the partitioning information may include a serial number and the number of pieces of data that are partitioned from the firmware.

For example, “0103” set for the firmware of version 1.0 indicates that the firmware of version 1.0 is partitioned into three pieces of firmware data and the serial number is “01.” “0303” set for the firmware of version 1.0 indicates that the firmware of version 1.0 is partitioned into three pieces of firmware data and the serial number is “03.” The partitioning information may include only the number of pieces of data that are partitioned from the firmware without the serial number. That is, the serial number may be omitted.

The first meta-information may further include a message authentication code (MAC) chaining value and length information of each firmware data. The length information may include, for example, a payload length and a padding length of each firmware data.

The MAC chaining value and the length information will be described later.

For example, the second apparatus may transmit the first meta-information to the apparatus 100 in a multicast manner, for example, by using a user datagram protocol (UDP).

The apparatus 100 may receive the first meta-information transmitted by using the UDP.

Next, in step S120, the apparatus 100 generates, based on the first meta-information, second meta-information for one or more pieces of firmware data to be used to apply the firmware to the apparatus 100, among the multiple pieces of firmware data.

For example, the apparatus 100 may generate the second meta-information for the one or more pieces of firmware data based on the comparison of the version information of the firmware stored in advance in the apparatus 100 with the version information included in the history information of the first meta-information received through step S110.

For example, if the version information of the firmware stored in advance in the apparatus 100 indicates the version 1.0 and the version information included in the history information of the first meta-information indicates the version 3.0, the apparatus 100 receives the four pieces of firmware data corresponding to the firmware of version 3.0 in the first meta-information shown in FIG. 4 and the two pieces of firmware data corresponding to the firmware of version 2.0 that may themselves constitute the firmware of version 2.0.

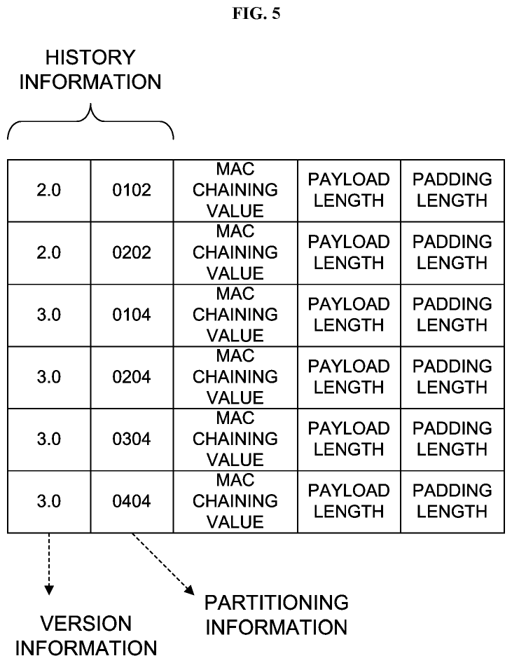

As a result, the second meta-information is generated, for example, as shown in FIG. 5.

FIG. 5 is a diagram illustrating an example of a structure of the second meta-information in the method for receiving firmware according to the first embodiment of the technique of the present disclosure.

The second meta-information may include at least history information for each of the one or more pieces of firmware data. The second meta-information may further include a MAC chaining value and length information of each firmware data.

Since the details of the structure of the second meta-information are substantially the same as those of the structure of the first meta-information, a detailed description thereof will be omitted.

Next, in step S130, the apparatus 100 receives the one or more pieces of firmware data from the firmware providing apparatus 200 or the second apparatus based on the second meta-information.

For example, the apparatus 100 may send a request for transmission of the one or more pieces of firmware data to the firmware providing apparatus 200 and receive the one or more pieces of firmware data from the firmware providing apparatus 200.

Alternatively, the apparatus 100 may first determine whether the one or more pieces of firmware data can be received from the second apparatus.

In other words, in the case that the second apparatus stores one or more pieces of firmware data and is capable of providing one or more pieces of firmware to the apparatus 100, the apparatus 100 preferably receives the one or more pieces of firmware data from the second apparatus.

Accordingly, in one example, the apparatus 100 sends a request to the second apparatus for confirmation of whether the one or more pieces of firmware data can be provided from the second apparatus. Upon receiving a response from the second apparatus indicating that the one or more pieces of firmware data can be provided, the apparatus 100 sends a request for transmission of the one or more pieces of firmware data to the second apparatus. On the other hand, upon receiving a response from the second apparatus indicating that the one or more pieces of firmware data cannot be provided, the apparatus 100 sends a request for transmission of the one or more pieces of firmware data to the firmware providing apparatus 200.

If the second apparatus stores the one or more pieces of firmware data and is capable of providing the one or more pieces of firmware to the apparatus 100, the apparatus 100 may receive the one or more pieces of firmware from the second apparatus without the intervention of the firmware providing apparatus 200.

Hereinafter, a process of receiving the one or more pieces of firmware data in step S130 will be described in detail.

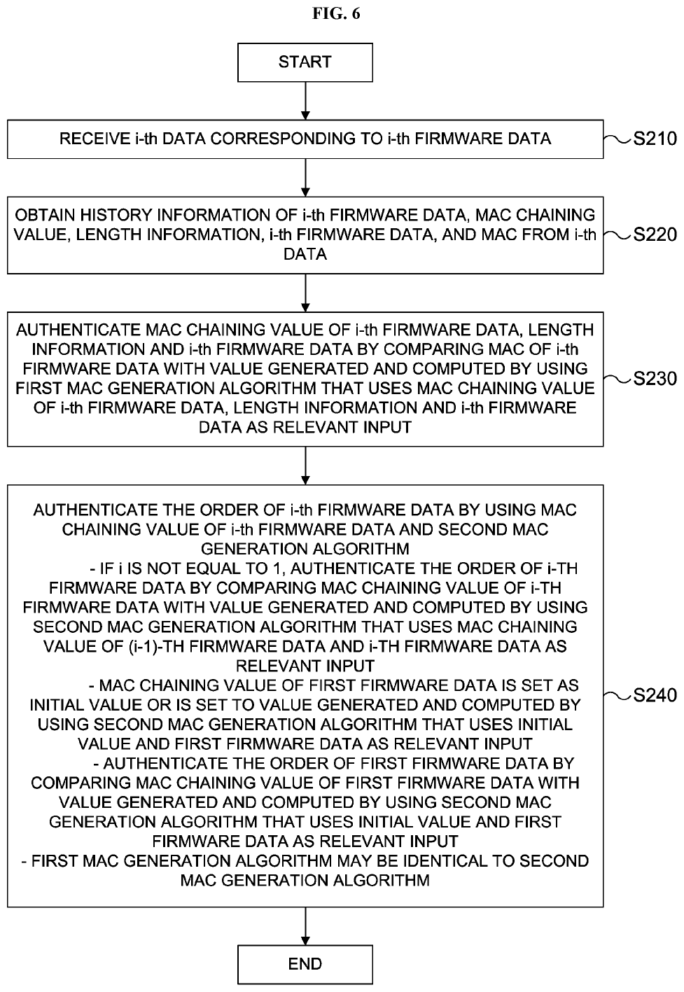

FIG. 6 is an exemplary flowchart of the process of receiving firmware data in the method for receiving firmware according to the first embodiment of the technique of the present disclosure.

The one or more pieces of firmware data may include first firmware data to n-th firmware data, where ‘n’ is a natural number equal to or greater than 2.

Hereinafter, a process of receiving i-th firmware data of the one or more pieces of firmware data, where “i” is a natural number from 1 to n, will be described in detail.

The apparatus 100 first receives i-th data corresponding to the i-th firmware data (step S210).

For example, the i-th data may be transmitted in the unicast manner or the multicast manner from the firmware providing apparatus 200.

That is, when the i-th data is transmitted to one or more apparatuses in the multicast group, the firmware providing apparatus 200 may transmit the i-th data to the apparatus 100 in the multicast manner.

Alternatively, when the i-th data is to be transmitted only to the apparatus 100, the firmware providing apparatus 200 may transmit the i-th data to the apparatus 100 in the unicast manner.

The second apparatus may also transmit the i-th data in the unicast manner or the multicast manner.

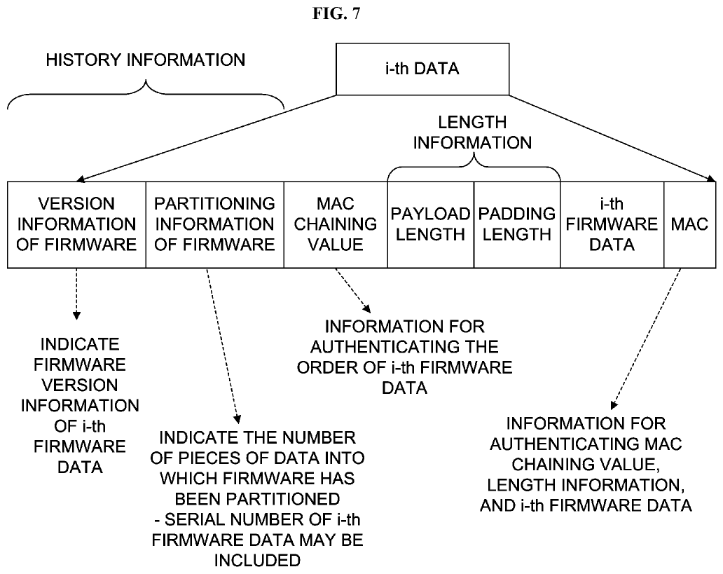

FIG. 7 is a diagram illustrating an example of a structure of the i-th data in the method for receiving firmware according to the first embodiment of the technique of the present disclosure.

Referring to FIG. 7, the i-th data includes history information of the i-th firmware data, a MAC chaining value of the i-th firmware data, length information (specifically, a payload length and a padding length), the i-th firmware data, and MAC.

Since the history information is described previously, the description of the history information will be omitted.

The MAC chaining value of the i-th firmware data serves as information for authenticating the sequential order of the i-th firmware data.

The length information (more specifically, the payload length and the padding length) may include the length of the payload and the length of the padding in the i-th firmware data. The i-th firmware data may contain only the payload, but may also contain the padding.

The MAC of the i-th firmware data serves as information for authenticating the MAC chaining value of the i-th firmware data, the length information of the i-th firmware data, and the i-th firmware data.

The description of the structure of the i-th data shown in FIG. 7 is merely an example, and the first embodiment of the technique of the present disclosure is not limited thereto.

Next, from the i-th data, the apparatus 100 obtains the history information of the i-th firmware data, the MAC chaining value of the i-th firmware data, the length information (e.g., the payload length and the padding length), the i-th firmware data, and the MAC (step S220).

Next, the apparatus 100 authenticates the MAC chaining value of the i-th firmware data, the length information, and the i-th firmware data by comparing the MAC of the i-th firmware data with a value generated and computed by using a first MAC generation algorithm, which uses the MAC chaining value of the i-th firmware data, the length information, and the i-th firmware data as the relevant input (step S230). In other words, the apparatus 100 authenticates the MAC chaining value of the i-th firmware data, the length information, and the i-th firmware data obtained in step S220 by comparing the MAC of the i-th firmware data obtained in step S220 with the value generated according to the first MAC generation algorithm (that is, the MAC of the i-th firmware data computed by using the first MAC generation algorithm).

The first MAC generation algorithm may be implemented using a function such as a hash function.

If the MAC of the i-th firmware data obtained in step S220 is the same as the value generated and computed in S230 by using the first MAC generation algorithm, which uses the MAC chaining value of the i-th firmware data, the length information, and the i-th firmware data as the relevant input, the apparatus 100 may determine that the MAC chaining value of the i-th firmware data, the length information, and the i-th firmware data obtained in step S220 have not been forged or tampered with.

If the MAC of the i-th firmware data obtained in step S220 is different from the value generated and computed in S230 by using the first MAC generation algorithm, which uses the MAC chaining value of the i-th firmware data, the length information, and the i-th firmware data as the relevant input, the apparatus 100 may determine that the MAC chaining value of the i-th firmware data, the length information, and the i-th firmware data obtained in step S220 have been forged or tampered with.

Next, the apparatus 100 authenticates the sequential order of the i-th firmware data by using the MAC chaining value of the i-th firmware data and a second MAC generation algorithm (step S240).

The MAC chaining value of the first firmware data may be set as an initial value. In that case, the apparatus 100 may determine that the i-th firmware data is the first firmware data if the MAC chaining value of the i-th firmware data is the initial value. For example, if “i” is not equal to 1, that is, if the MAC chaining value of the i-th firmware data is not the initial value, the apparatus 100 may compare the MAC chaining value of the i-th firmware data with a value generated and computed by using the second MAC generation algorithm, which uses a MAC chaining value of (i-1)-th firmware data and the i-th firmware data as the relevant input, to thereby authenticate the sequential order of the i-th firmware data.

The second MAC generation algorithm may be implemented using a function such as a hash function.

It is preferred that the first MAC generation algorithm, which is used to authenticate the MAC chaining value of the i-th firmware data, the length information, the i-th firmware data, is the same as the second MAC generation algorithm, which is used to authenticate the sequential order of the i-th firmware data. However, the first MAC generation algorithm may be different from the second MAC generation algorithm.

Since it is known that the MAC chaining value of the first firmware data is the initial value, the sequential order of each of second firmware data to the n-th firmware data can be authenticated based on the MAC chaining value of each of the second firmware data to the n-th firmware data.

For example, when “i” is equal to 2, the apparatus 100 compares the MAC chaining value of the second firmware data obtained in step S220 with a value generated and computed in step S240 by using the second MAC generation algorithm that uses the MAC chaining value of the first firmware data and the second firmware data as the relevant input.

If the MAC chaining value of the second firmware data obtained in step S220 is the same as the value generated and computed in step S240 by using the second MAC generation algorithm that uses the MAC chaining value of the first firmware data and the second firmware data as the relevant input, the sequential order of the firmware data can be determined that the second firmware data is subsequent to the first firmware data.

If the MAC chaining value of the second firmware data obtained in step S220 is different from the value generated and computed in step S240 by using the second MAC generation algorithm that uses the MAC chaining value of the first firmware data and the second firmware data as the relevant input, the sequential order of the firmware data can be determined that the second firmware data is not subsequent to the first firmware data. Alternatively, the apparatus 100 determines that at least one of the MAC chaining value of the first firmware data or the second firmware has been forged or tampered with.

Meanwhile, the MAC chaining value of the first firmware data may be set to a value generated and computed by using the second MAC generation algorithm that uses the initial value and the first firmware data as the relevant input. If “i” is not equal to 1, the apparatus 100 authenticates the sequential order of the i-th firmware data by comparing the MAC chaining value of the i-th firmware data with the value generated and computed by using the second MAC generation algorithm, which uses the MAC chaining value of the (i-1)-th firmware data and the i-th firmware data as the relevant input, as described above. Further, even when “i” is equal to 1, the apparatus 100 may authenticate the sequential order of the first firmware data by comparing the MAC chaining value of the first firmware data with the value generated and computed by using the second MAC generation algorithm that uses the initial value and the first firmware data as the relevant input. That is, the apparatus 100 may authenticate that the first firmware data is the first data of the multiple pieces of firmware data that are partitioned from the firmware.

As discussed above, through step S230 and step S240, it is possible for the apparatus 100 to authenticate the MAC chaining value of the i-th firmware data, the length information, and the i-th firmware data. Further, it is possible for the apparatus 100 to authenticate the sequential order of the i-th firmware data. Therefore, even if data is forged, for example, a part of the i-th data is forged, and the forged data is transmitted to the apparatus 100, the apparatus 100 can easily determine whether the i-th data (more specifically, the i-th firmware data) has been forged or not.

In particular, the apparatus 100 may easily determine whether the i-th data (more specifically, the i-th firmware data) has been forged or not by using both the MAC and the MAC chaining value.

In the above description, the first embodiment has been described on the basis that step S240 is executed after step S230 is executed. However, the first embodiment of the technique of the present disclosure is not limited thereto. For example, step S240 may be executed first and step S230 may be executed next, or step S230 and step S240 may be executed simultaneously or in parallel.

When the one or more pieces of firmware data to be used to apply the firmware to the apparatus 100 are received through steps S110 to S130, the apparatus 100 may update the firmware.

Referring back to FIG. 1, in step S140, the apparatus 100 may send a request for transmission of the first meta-information to the second apparatus.

That is, in the case when the apparatus 100 newly joins the multicast group; the apparatus 100 is powered on from the power-off state; or the apparatus 100 shifts to the normal state from the standby state, the apparatus 100 may send the request for transmission of the first meta-information to the second apparatus.

In response to step S140, the second apparatus transmits the first meta-information to the apparatus 100, and the apparatus 100 may receive the first meta-information through step S110.

Referring again to FIG. 1, in step S150, the apparatus 100 may decrypt each of the first firmware data to the n-th firmware data with the predetermined encryption key.

That is, each of the first firmware data to the n-th firmware data may be encrypted

data.

Accordingly, the apparatus 100 may decrypt each of the first firmware data to the n-th firmware data obtained by performing step S130 by using a predetermined encryption key and a predetermined encryption algorithm, and then update the firmware with the first firmware data to the n-th firmware data.

Referring again to FIG. 1, in step S160, if there is missing data that is not received among the first data to the n-th data even after performing step S130, the apparatus 100 may send a request for retransmission of the missing data to the firmware providing apparatus 200.

For example, if third data is not received among the first data to the n-th data, the apparatus 100 generates a request for retransmission of the third data and sends the generated request to the firmware providing apparatus 200.

Next, in step 170, the apparatus 100 receives, from the firmware providing apparatus 200, data that is retransmitted in the unicast manner or retransmitted in the multicast manner to an additional multicast group including the apparatus 100. Here, the additional multicast group belongs to the multicast group 300.

For example, the firmware providing apparatus 200 may retransmit the third data to the apparatus 100 in the unicast manner. Alternatively, for example, if the third data needs to be retransmitted to one or more apparatus that include the apparatus 100 among the apparatuses 100-1 to 100-x, the firmware providing apparatus 200 may retransmit the third data in the multicast manner to a multicast group (i.e., the additional multicast group) that includes the one or more apparatus.

As described above, according to the first embodiment, at least a part of the firmware can be obtained from the firmware providing apparatus or the neighboring apparatus based on the history information of the firmware. Further, by using the MAC and the MAC chaining value, it is possible to easily determine whether the firmware data has been forged and further determine the sequential order of the firmware data. Furthermore, for any missing firmware data that has not been received, the apparatus may receive the missing firmware data again in the unicast manner or the multicast manner.

### Second Embodiment

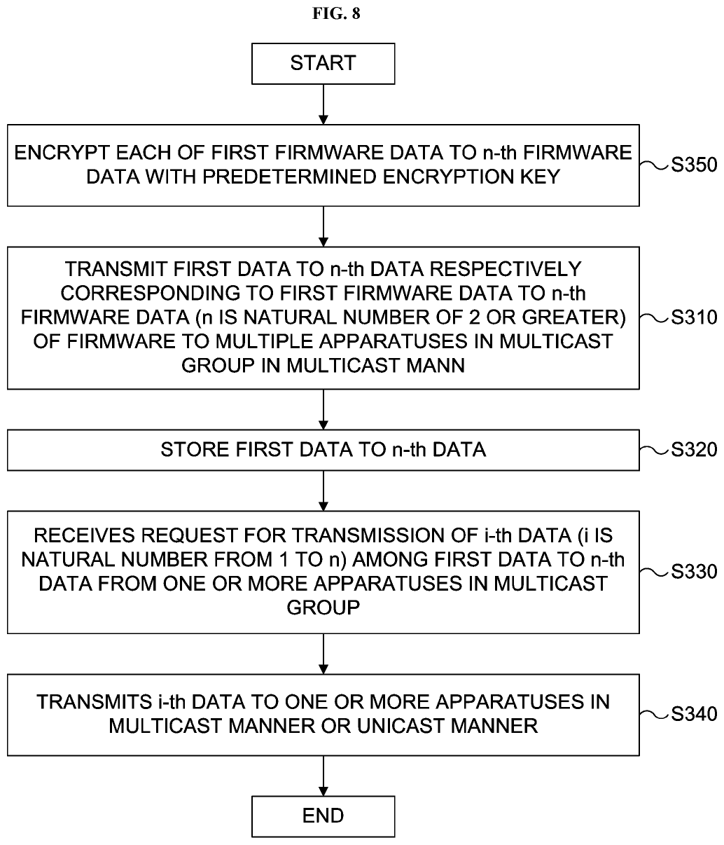

FIG. 8 is an exemplary flowchart of a method for transmitting firmware according to a second embodiment of the technique of the present disclosure.

The detailed description of configurations of the second embodiment that are substantially similar to those described in the first embodiment will be omitted.

Referring to FIG. 8, in step S310, the firmware providing apparatus 200 transmits the first data to the n-th data respectively corresponding to the first firmware data to the n-th firmware data (where n is a natural number of 2 or greater) of the firmware to the plurality of apparatuses in the multicast group 300 in the multicast manner.

For example, step S310 is described with reference to the first meta-information of FIG. 4.

Assuming that there are three pieces of data, for example, data #1 to data #3 for the firmware of version 1.0, two pieces of data, for example, data #4 and data #5 for the firmware of version 2.0, and four pieces of data, for example, data #6 to data #9 for the firmware of version 3.0.

For example, when the firmware of version 1.0 is obtained, the firmware providing apparatus 200 transmits the three pieces of data, i.e., data #1 to data #3 to the plurality of apparatuses in the multicast group 300 in the multicast manner.

Thereafter, in the case when the firmware of version 2.0 is obtained, the firmware providing apparatus 200 transmits the two pieces of data, i.e., data #4 and data #5 to the plurality of apparatuses in the multicast group 300 in the multicast manner.

Thereafter, in the case when the firmware of version 3.0 is obtained, the firmware providing apparatus 200 transmits the four pieces of data, i.e., data #6 to data #9 to the plurality of apparatuses in the multicast group 300 in the multicast manner.

Each of the aforementioned versions of the firmware is executed, for example, after the firmware is created by a developer and uploaded to the firmware providing apparatus 200.

Next, in step S320, the firmware providing apparatus 200 stores the first data to the n-th data.

Next, in step S330, the firmware providing apparatus 200 receives a request for transmission of i-th data (where “i” is a natural number from 1 to n) among the first data to the n-th data from one or more apparatuses in the multicast group 300.

Next, in step S340, the firmware providing apparatus 200 transmits the i-th data to the one or more apparatuses in the multicast manner or the unicast manner.

For example, when the i-th data is to be transmitted only to the apparatus 100, the firmware providing apparatus 200 may retransmit the i-th data to the apparatus 100 in the unicast manner. Alternatively, for example, when the i-th data is to be retransmitted to one or more apparatuses that include the apparatus 100, the firmware providing apparatus 200 may retransmit the i-th data in the multicast manner to the multicast group (i.e., the additional multicast group) that includes the one or more apparatus.

Hereinafter, the structure of the i-th data will be described in detail. Since the structure of each of the first data to the n-th data is substantially the same as the structure of the i-th data, a detailed description thereof will be omitted.

The i-th data includes the history information including the version information and the partitioning information of the i-th firmware data, the MAC chaining value of the i-th firmware data, the length information, the i-th firmware data, and the MAC.

Since the history information in the i-th data is previously described in the first embodiment, the detailed description thereof will be omitted.

The MAC of the i-th firmware data is generated and computed by using a first MAC generation algorithm that uses the MAC chaining value of the i-th firmware data, the length information, and the i-th firmware data as the relevant input.

The MAC chaining value of the i-th firmware data is generated and computed by using a second MAC generation algorithm that uses a MAC chaining value of (i-1)-th firmware data and the i-th firmware data as the relevant input, if “i” is not equal to 1.

As described above, the MAC of the i-th firmware data may be generated and computed by using the first MAC generation algorithm that uses the MAC chaining value of the i-th firmware data, the length information, and the i-th firmware data as the relevant input.

A MAC chaining value of first firmware data may be set as an initial value. Alternatively, the MAC chaining value of the first firmware data may be generated and computed by using the second MAC generation algorithm that uses the initial value and the first firmware data as the relevant input.

The first MAC generation algorithm may be identical to the second MAC generation algorithm.

Meanwhile, referring to FIG. 8, the firmware providing apparatus 200 may encrypt each of the first firmware data to the n-th firmware data with a predetermined encryption key in step S350.

As described above, according to the second embodiment, the firmware providing apparatus may transmit firmware data to an apparatus within the multicast group by using the multicast method. In addition, even when the multicast method is used, the MAC and the MAC chaining value are provided so that each apparatus within the multicast group can easily determine the sequential order of the partitioned firmware data and whether the firmware data has been forged by using the MAC and the MAC chaining value. Further, in response to a retransmission request, the firmware providing apparatus may retransmit at least some of the multiple pieces of the firmware data to one or more apparatuses in the multicast group by using a unicast method or the multicast method.

### Other Embodiments

While the technique of the present disclosure is described in detail by way of the embodiments described above, the technique of the present disclosure is not limited thereto and may be modified in various ways without departing from the scope thereof

For example, the above-described structure of the i-th data is merely an example and may be modified in various ways.

For example, the technique of the present disclosure may also be applied to apparatuses that receive firmware in a multicast group and apparatuses that provide firmware to a plurality of apparatuses in the multicast group.

For example, an apparatus for receiving firmware according to the technique of the present disclosure may include an operation processor that is configured to (a) receive first meta-information for the multiple pieces of firmware data from the second apparatus in a multicast group; (b) generate, based on the first meta-information, second meta-information for one or more pieces of firmware data to be used to apply the firmware to the first apparatus, among the multiple pieces of firmware data; and (c) receive, based on the second meta-information, the one or more pieces of firmware data from an apparatus providing the firmware or the second apparatus.

For example, an apparatus for providing firmware according to the technique of the present disclosure may include an operation processor that is configured to (a) transmit first data to n-th data respectively corresponding to first firmware data to n-th firmware data of the firmware to a plurality of apparatuses in a multicast group in a multicast manner, where “n” is a natural number of 2 or greater; (b) store the first data to the n-th data; (c) receive a request for transmission of i-th data among the first data to the n-th data from one or more apparatuses in the multicast group, where “i” is a natural number from 1 to n; and (d) transmit the i-th data to the one or more apparatuses in a multicast manner or a unicast manner.

Specific technical features described with reference to the first and second embodiments of the technique of the present disclosure may be applied in a similar way to an apparatus for receiving firmware and an apparatus for providing firmware.

Accordingly, the exemplary embodiments disclosed herein are not used to limit the technical idea of the present disclosure, but to explain the present disclosure, and the scope of the technical idea of the present disclosure is not limited by those embodiments. Therefore, the scope of protection of the present disclosure should be construed as defined in the following claims, and all technical ideas that fall within the technical idea of the present disclosure are intended to be embraced by the scope of the claims of the present disclosure.

### INDUSTRIAL APPLICABILITY

According to some embodiments of the technique of the present disclosure, it is possible to obtain at least a part of firmware from an apparatus for providing firmware or a neighboring apparatus based on history information of the firmware. Further, by using MAC and MAC chaining values, it is possible to easily determine whether firmware data has been forged and further determine the sequential order of firmware data. Furthermore, for any missing firmware data that has not been received, the apparatus may receive the missing firmware data again in the unicast manner or the multicast manner.

Furthermore, according to some embodiments of the technique of the present disclosure, even when the firmware is transmitted in a multicast manner, it is possible to transmit the firmware while the MAC and MAC chaining values are used to prevent the firmware tampering. In addition, by using the history information of the firmware, an apparatus that receives the firmware can transmit only the data necessary to apply the firmware based on the history information, thereby minimizing the communication load.

What is claimed is:

1. A method for receiving firmware including multiple pieces of firmware data, which is performed by a first apparatus in a multicast group including at least the first apparatus and a second apparatus, the method comprising:
(a) receiving first meta-information for the multiple pieces of firmware data from the second apparatus;
(b) generating, based on the first meta-information, second meta-information for one or more pieces of firmware data to be used to apply the firmware to the first apparatus, among the multiple pieces of firmware data; and
(c) receiving, based on the second meta-information, the one or more pieces of firmware data from an apparatus providing the firmware or the second apparatus, wherein the first meta-information includes at least history information including version information and partitioning information for each of the multiple pieces of firmware data, and
the second meta-information includes at least the history information for each of the one or more pieces of firmware data.

2. The method of claim 1, further comprising:
(d) sending a request for transmission of the first meta-information to the second apparatus before (a) is performed.

3. The method of claim 1, wherein (a) includes (a-1) receiving the first meta-information transmitted in a multicast manner from the second apparatus.

4. The method of claim 1, wherein (b) includes (b-1) generating the second meta-information for the one or more pieces of firmware data based on a comparison of version information of firmware stored in advance in the first apparatus with the version information included in the history information of the first meta-information.

5. The method of claim 1, wherein (c) includes:
(c-1) determining that the one or more pieces of firmware data is receivable from the second apparatus, and
(c-2) sending a request for transmission of the one or more pieces of firmware data to the second apparatus if the one or more pieces of firmware data is receivable from the second apparatus, and sending a request for transmission of the one or more pieces of firmware data to the apparatus providing the firmware if the one or more pieces of firmware data is not receivable from the second apparatus.

6. The method of claim 1, wherein the one or more pieces of firmware data include first firmware data to n-th firmware data where n is a natural number equal to or greater than 2, and
(c) further includes:
(c-3) for i-th firmware data among the one or more pieces of firmware data where “i” is a natural number from 1 to n,
(c-3-1) receiving i-th data corresponding to the i-th firmware data;
(c-3-2) obtaining the history information of the i-th firmware data, a message authentication code (MAC) chaining value, length information, the i-th firmware data, and MAC from the i-th data;
(c-3-3) authenticating the MAC chaining value of the i-th firmware data, the length information, and the i-th firmware data by comparing the MAC of the i-th firmware data with a value generated and computed by using a first MAC generation algorithm, which uses the MAC chaining value of the i-th firmware data, the length information, and the i-th firmware data as a relevant input; and
(c-3-4) authenticating the sequential order of the i-th firmware data by using the MAC chaining value of the i-th firmware data and a second MAC generation algorithm.

7. The method of claim 6, wherein the MAC chaining value of the first firmware data is set as an initial value, and
in (c-3-4), if “i” is not equal to 1, the MAC chaining value of the i-th firmware data is compared with a value generated and computed by using the second MAC generation algorithm, which uses a MAC chaining value of (i-1)-th firmware data and the i-th firmware data as a relevant input, to authenticate the sequential order of the i-th firmware data.

8. The method of claim 6, wherein the MAC chaining value of the first firmware data is set to a value generated and computed by using the second MAC generation algorithm that uses an initial value and the first firmware data as a relevant input, and
in (c-3-4), if “i” is not equal to 1, the MAC chaining value of the i-th firmware data is compared with a value generated and computed by using the second MAC generation algorithm, which uses a MAC chaining value of (i-1)-th firmware data and the i-th firmware data as a relevant input, to authenticate the sequential order of the i-th firmware data.

9. The method of claim 8, wherein, in (c-3-4), the MAC chaining value of the first firmware data is compared with a value generated and computed by using the second MAC generation algorithm that uses the initial value and the first firmware data as a relevant input to authenticate the sequential order of the first firmware data.

10. The method of claim 6, wherein the first MAC generation algorithm is the same as the second MAC generation algorithm.

11. The method of claim 6, wherein the i-th data is transmitted in a unicast manner or a multicast manner.

12. The method of claim 6, further comprising:
(e) decrypting each of the first firmware data to the n-th firmware data with a predetermined encryption key.

13. The method of claim 6, further comprising:
(f) sending a request for retransmission of data that is not received among first data to n-th data to the apparatus providing the firmware, and
(g) receiving, from the apparatus providing the firmware, the data that is retransmitted in a unicast manner or retransmitted in a multicast manner to an additional multicast group including the first apparatus in the multicast group.

14. A method for transmitting firmware to a plurality of apparatuses in a multicast group, which is performed by a firmware providing apparatus, the method comprising:
(a) transmitting first data to n-th data respectively corresponding to first firmware data to n-th firmware data of the firmware to the plurality of apparatuses in the multicast group in a multicast manner, wherein “n” is a natural number of 2 or greater;
(b) storing the first data to the n-th data;
(c) receiving a request for transmission of i-th data among the first data to the n-th data from one or more apparatuses in the multicast group, wherein “i” is a natural number from 1 to n; and
(d) transmitting the i-th data to the one or more apparatuses in a multicast manner or a unicast manner,
wherein the i-th data includes history information including version information and partitioning information of i-th firmware data, a MAC chaining value, length information, the i-th firmware data, and the MAC,
the MAC of the i-th firmware data is generated and computed by using a first MAC generation algorithm that uses the MAC chaining value of the i-th firmware data, the length information, and the i-th firmware data as a relevant input, and
the MAC chaining value of the i-th firmware data is generated and computed by using a second MAC generation algorithm that uses a MAC chaining value of (i-1)-th firmware data and the i-th firmware data as a relevant input, if “i” is not equal to 1.

15. The method of claim 14, wherein the MAC chaining value of the first firmware data is generated and computed by using the second MAC generation algorithm that uses an initial value and the first firmware data as a relevant input,

16. The method of claim 14, wherein the MAC chaining value of the first firmware data is set as an initial value.

17. The method of claim 14, wherein the first MAC generation algorithm is the same as the second MAC generation algorithm.

18. The method of claim 14, further comprising:
(e) encrypting each of the first firmware data to the n-th firmware data with a predetermined encryption key before (a) is performed.
